(19) United States
(12) Patent Application Publication
(10) Pub. No.: US 2012/0248811 A1
(43) Pub. Date: Oct. 4, 2012

(54) MAGNESIUM ALLOY SHEET METAL PANEL WITH ABRASIVLEY PROCESSED EDGE REGION FOR ENHANCED DURABILITY

(75) Inventors: Guangling Song, Troy, MI (US); Jon T. Carter, Farmington, MI (US)

(73) Assignee: GM GLOBAL TECHNOLOGY OPERATIONS LLC, Detroit, MI (US)

(21) Appl. No.: 13/075,466

(22) Filed: Mar. 30, 2011

(51) Int. Cl. B62D 25/10; B21D 28/00

(52) U.S. Cl. 296/76; 72/338; 296/146.1

(57) ABSTRACT

An inner body panel for a vehicle, e.g., an inner panel for a trunk lid assembly, is manufactured from a magnesium alloy, and includes an abrasively rounded edge surface along an edge of the panel. The rounded edge surface includes a radius that is equal to one half the thickness of the inner panel. The rounded edge surface allows for a uniform deposition of a corrosion resistant coating along the edge of the panel.

### TECHNICAL FIELD

The invention generally relates to a method of finishing a panel for a vehicle, and more specifically to a trunk lid assembly and a method of manufacturing the trunk lid assembly.

### BACKGROUND

Trunk lid assemblies for vehicles typically include an outer panel and an inner panel. The outer panel and the inner panel each define an edge, e.g., a lower edge. The lower edge of the outer panel extends beyond the lower edge of the inner panel, and is bent around and back against the inner panel to form a hem connection securing the inner panel to the outer panel. In order to reduce the overall weight of the vehicle, the inner panel may be manufactured from a magnesium alloy material. The inner panel is coated with a corrosion resistant material to prevent corrosion of the magnesium alloy material. However, due to the sheet metal cutting process used to trim the inner panel, the edges of the magnesium alloy inner panel are typically jagged with rough corners. These jagged and rough corners along the edge of the magnesium alloy inner panel prevent a uniform deposition of the corrosion resistant coatings on the edge, thereby reducing the effectiveness of the corrosion resistant coating.

### SUMMARY

A method of manufacturing a closure assembly for a vehicle is provided. The method includes trimming an outer panel to define an edge, and trimming an inner panel to define an edge. The outer panel is formed from an aluminum alloy material, and the inner panel is formed from a magnesium alloy material. The edge of the inner panel is abrasively shaped to define a substantially rounded edge surface having a radius. The inner panel is positioned adjacent the outer panel such that the edge of the outer panel extends beyond the rounded edge surface of the inner panel. The method further includes bending the edge of the outer panel around the rounded edge surface of the inner panel to form a hem connection that secures the inner panel relative to the outer panel.

A method of forming a panel for a vehicle is also provided. The method includes abrasively shaping an edge of the panel to define a substantially rounded edge surface having a radius and to remove surface contaminants, wherein the panel includes a magnesium alloy material, and wherein the radius of the rounded edge surface is between the range of one quarter (¼) a thickness of the panel and one half (½) the thickness of the panel. The panel is coated with a corrosion resistant surface treatment after abrasively shaping the rounded edge surface.

A closure assembly for a vehicle is also provided. The closure assembly includes an outer panel and an inner panel. The outer panel includes an edge and defines an exterior surface and an interior surface. The inner panel includes an edge and defines a first surface and a second surface. The inner panel is positioned adjacent the outer panel such that the first surface of the inner panel engages the interior surface of the outer panel along a bondline region. The edge of the outer panel is bent over and wrapped around the edge of the inner panel such that the interior surface of the outer panel engages the second surface of the inner panel along a hem region to define a hem connection. The edge of the inner panel is abrasively shaped to define a substantially rounded edge surface having a smooth radius.

Accordingly, the abrasively shaped rounded edge surface along the edge of the magnesium alloy inner panel removes any jagged and/or rough corners along the edge of the inner panel, thereby allowing for the corrosion resistant coating to be applied in a uniform thickness. Applying the corrosion resistant coating in a uniform thickness along the rounded edge surface improves the corrosion resistance of the magnesium alloy panel. Additionally, abrasively finishing the bondline region and the hem region, where the magnesium alloy material of the inner panel contacts the aluminum alloy material of the outer panel, improves adherence of the corrosion resistant coating to the magnesium alloy panel, thereby improving the corrosion resistance of the magnesium alloy panel in the bondline region and the hem region.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a trunk lid assembly.

FIG. 2 is a schematic cross sectional view of a lower hem connection between an inner panel and an outer panel of the trunk lid assembly.

FIG. 3 is an enlarged schematic cross sectional view of a rounded edge surface of the inner panel.

FIG. 4 is a schematic cross sectional view of the inner panel positioned adjacent the outer panel prior to bending the outer panel to define the hem connection.

FIG. 5 is an enlarged schematic cross sectional view of an alternative embodiment of the rounded edge surface of the inner panel.

### DETAILED DESCRIPTION

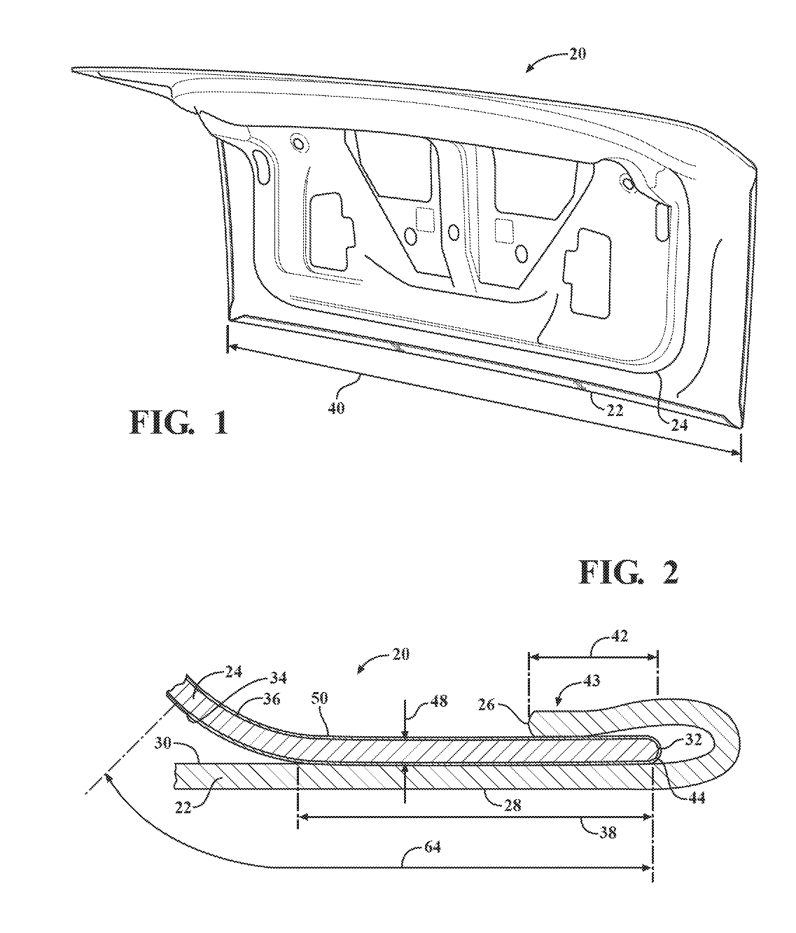

Referring to the Figures, wherein like numerals indicate like parts throughout the several views, a closure assembly is shown generally at 20 in FIG. 1. The closure assembly 20 is for a vehicle. As shown, the closure assembly 20 includes and is hereafter referred to as a trunk lid assembly 20. However, it should be appreciated that the closure assembly 20 may include any type and/or style of closure assembly 20, including but not limited to a side passenger door, a rear cargo door, a cargo door or a hood.

Referring to FIG. 2, the trunk lid assembly 20 includes an outer panel 22 and an inner panel 24. The outer panel 22 includes at least one edge 26, including but not limited to a lower edge or a side edge of the outer panel 22. The outer panel 22 defines an exterior surface 28 and an interior surface 30, and is manufactured from an aluminum alloy material. As used herein, the terminology “aluminum alloy material” refers to alloys in which aluminum is the predominant constituent. Other alloying constituents of the aluminum alloy material may include, for example, copper, magnesium, manganese, silicon, chromium, zinc, and lithium. A non-limiting example of a suitable aluminum alloy material is AA6111 aluminum alloy. The inner panel 24 includes at least one edge 32, including but not limited to a lower edge or a side edge of the inner panel 24. The inner panel 24 defines a first surface 34 and a second surface 36, and includes and is manufactured from a magnesium alloy material. As used herein, the terminology “magnesium alloy material” refers to alloys in which magnesium is the predominant constituent. Other alloying constituents of the magnesium alloy material may include, for example, copper, aluminum, manganese, silicon, zinc, and zirconium. A non-limiting example of a suitable magnesium alloy material is AZ31B magnesium alloy.

The first surface 34 of the inner panel 24 includes a bondline region 38 that is disposed adjacent the edge 32 of the inner panel 24 and extends along a length 40 of the edge 32, shown in FIG. 1. The second surface 36 includes a hem region 42 that is also disposed adjacent the edge 32 of the inner panel 24 and also extends along the length 40 of the edge 32. While the edge 32 of the inner panel 24, the edge 26 of the outer panel 22 and hem region 42 of the trunk lid assembly 20 are shown at a lower edge of FIG. 1, it should be appreciated that the edge 32 of the inner panel 24, the edge 26 of the outer panel 22 and hem region 42 of the trunk lid assembly 20 may be disposed along any edge of the trunk lid assembly, including but not limited to the vertical edges shown in FIG. 1.

As shown in FIG. 2, the inner panel 24 is positioned adjacent the outer panel 22 such that the first surface 34 of the inner panel 24 is disposed adjacent and engages the interior surface 30 of the outer panel 22 along the bondline region 38. The edge 26 of the outer panel 22 extends beyond the edge 32 of the inner panel 24, and is bent over and wrapped around the edge 32 of the inner panel 24 such that the interior surface 30 of the outer panel 22 is disposed adjacent and engages the second surface 36 of the inner panel 24 along the hem region 42, thereby defining a hem connection 43 between the inner panel 24 and the outer panel 22 to secure the inner panel 24 relative to the outer panel 22.

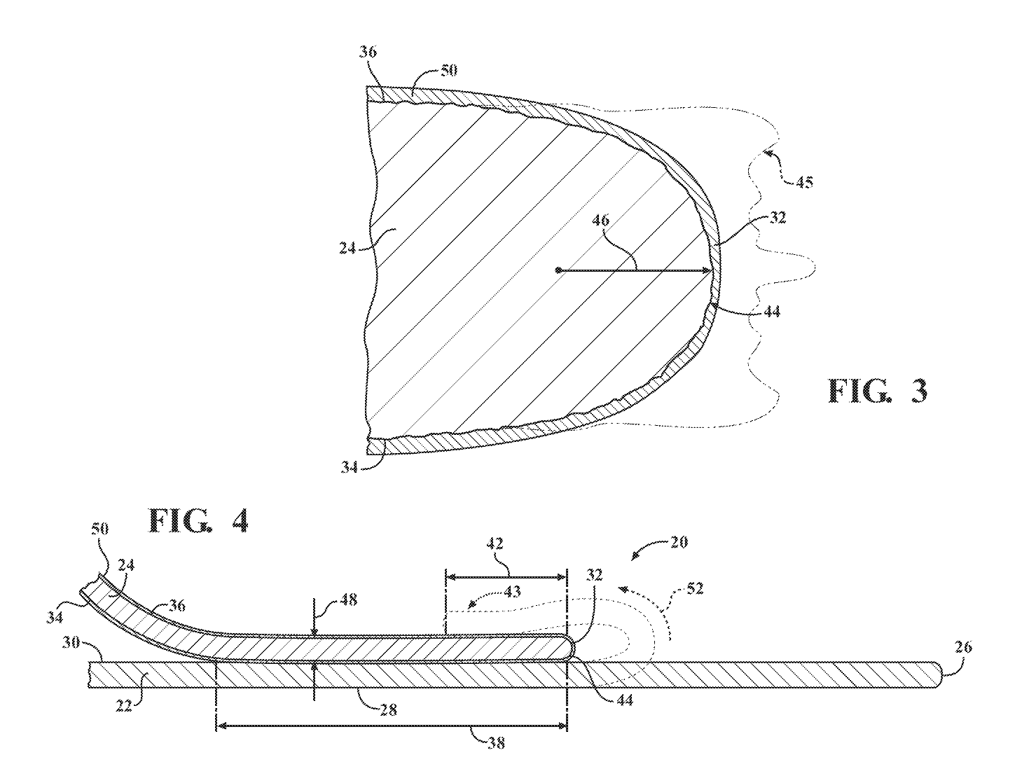

Referring to FIGS. 2 and 3, the edge 32 of the inner panel 24 is abrasively shaped, from an initial shape shown in phantom generally at 45 in FIG. 3, to define a substantially rounded edge surface 44 having a radius 46. Accordingly, both the bondline region 38 and the hem region 42 are disposed adjacent the rounded edge surface 44 and extend inward from the rounded edge surface 44 a distance.

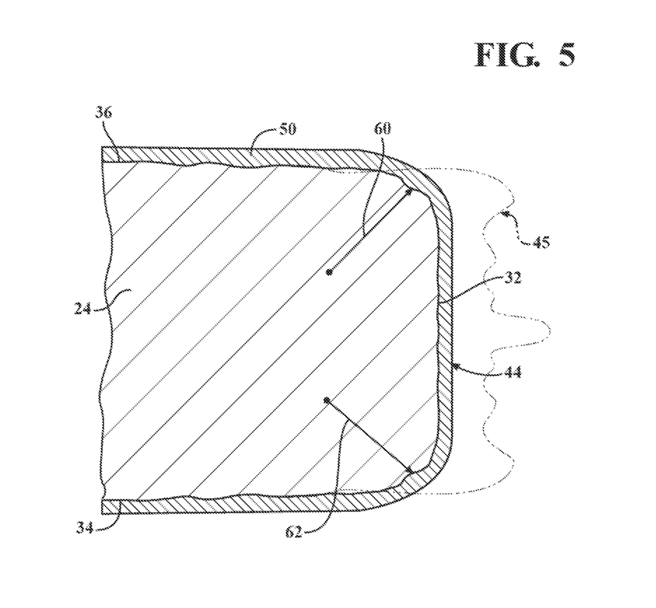

The inner panel 24 includes a thickness 48, with the radius 46 of the rounded edge surface 44 being equal to or between the range of one quarter (¼) the thickness 48 of the inner panel 24 and one half (½) the thickness 48 of the inner panel 24. Preferably the radius 46 of the rounded edge surface 44 is approximately equal to one half the thickness 48 of the inner panel 24, thereby defining a semicircular rounded edge surface 44. It should be appreciated that the radius 46 of the rounded edge surface 44 may not be exactly uniform along the length 40 of the edge 32 of the inner panel 24, thereby defining a variable radius 46 along the length 40 of the rounded edge surface 44, with the radius 46 varying between one quarter (¼) and one half (½) the thickness 48 of the inner panel 24. Referring to FIG. 5, the inner panel is shown with the rounded edge surface 44 having a radius less than one half (½) the thickness of the inner panel 24. Specifically, the inner panel 24 shown in FIG. 5 includes a first radius 60 and a second radius 62. In order to form the rounded edge surface 44 of the inner panel 24 shown in FIG. 5, the edge 32 of the inner panel 24 may be abrasively finished to define a generally flat surface, and thereafter the rounded edge surface 44 is abrasively formed to define the first radius 60 and the second radius 62.

It should be appreciated that a radius 46 greater than one half the thickness 48 of the inner panel 24 would create an undesirable sharp corner at the intersection between the first surface 34 of the inner panel 24 and the rounded edge surface 44, as well as between the second surface 36 of the inner panel 24 and the rounded edge surface 44. It has been discovered that the jagged edges and or sharp corners along the edge 32 of the magnesium alloy inner panel 24 prevent uniform deposition of a corrosion resistant coating, thereby leading to corrosion of the inner panel 24 along the edge 32 thereof. The rounded edge surface 44 along the edge 32 of the inner panel 24 eliminates any jagged edges and/or sharp corners that may have been present in the edge 32 of the inner panel 24 when initially formed, such as by cutting a piece of sheet metal with shears or some other similar method. Eliminating the jagged edges and/or sharp corners allow for a uniform deposition of the corrosion resistant coatings, thereby improving the corrosion resistance of the magnesium alloy inner panel 24.

A method of manufacturing the trunk lid assembly 20 includes forming the outer panel 22 from the aluminum alloy material. The outer panel 22 is trimmed to define the edge 26 of the outer panel 22 as described above. The method further includes forming the inner panel 24 from the magnesium alloy material. The inner panel 24 is trimmed to define the edge 32 of the inner panel 24 as described above. While the method describes the manufacture of the trunk lid assembly 20, it should be appreciated that forming the inner panel 24 for the trunk lid assembly 20, including abrasively shaping the edge 32 of the panel as described below, may alternatively be applied to a method of forming any panel for the vehicle, including but not limited to doors, body panels, etc.

Finishing the inner panel 24 includes abrasively shaping the edge 32 of the inner panel 24 to define the substantially rounded edge surface 44 having the radius 46. As described above, the radius 46 of the rounded edge surface 44 is preferably equal to or between the range of one quarter (¼) the thickness 48 of the inner panel 24 and one half (½) the thickness 48 of the inner panel 24.

Abrasively shaping the edge 32 of the inner panel 24 may include sanding the edge 32 of the inner panel 24 with a medium grit abrasive to round the edge 32 of the inner panel 24 and define the radius 46, as well as to remove surface contaminants. Once the edge 32 of the inner panel 24 has been sanded with the medium grit abrasive, then abrasively shaping the edge 32 of the inner panel 24 may further include sanding the edge 32 of the inner panel 24 with a fine grit abrasive to remove any scratches left in the rounded edge surface 44 by the medium grit abrasive. The medium grit abrasive may include but is not limited to a one hundred eighty (180) grit bonded silicon carbide abrasive, and the fine grit abrasive may include but is not limited to a three hundred twenty (320) grit bonded silicon carbide abrasive. It should be appreciated that abrasive grits and abrasive materials other than those described herein may be used to abrasively shape the rounded edge surface 44.

The method further includes abrasively finishing the bondline region 38 and the hem region 42 of the inner panel 24. As described above, the bondline region 38 and the hem region 42 are the regions of the magnesium alloy inner panel 24 that contact the aluminum alloy outer panel 22 when assembled in place. Abrasively finishing the bondline region 38 and the hem region 42 of the inner panel 24 removes surface contaminants, and allows for better adhesion of the corrosion resistant coating to the magnesium alloy material of the inner panel 24. Preferably, the first surface 34 of the inner panel 24 is finished along a distance 64 that extends from the edge 32 of the inner panel 24 beyond the bondline region 38, thereby providing a high-quality coating up into the region where water and poultice might accumulate and otherwise initiate corrosion.

Abrasively finishing the bondline region 38 and the hem region 42 of the inner panel 24 may include but is not limited to sanding the bondline region 38 and the hem region 42 with a medium grit abrasive. Once the bondline region 38 and the hem region 42 are sanded with the medium grit abrasive, then abrasively finishing the bondline region 38 and the hem region 42 of the inner panel 24 may further include sanding the bondline region 38 and the hem region 42 with a fine grit abrasive to remove any scratches left in the bondline region 38 and the hem region 42 by the medium grit abrasive. The medium grit abrasive may include but is not limited to a one hundred eighty (180) grit bonded silicon carbide abrasive, and the fine grit abrasive may include but is not limited to a three hundred twenty (320) grit bonded silicon carbide abrasive. It should be appreciated that abrasive grits and abrasive materials other than those described herein may be used to abrasively shape the rounded edge surface 44.

After the edge 32 of the inner panel 24 is abrasively shaped to define the rounded edge surface 44, and the bondline region 38 and the hem region 42 have been abrasively finished to remove surface contaminates, then the method may further include coating the inner panel 24 with the corrosion resistant coating 50, best shown in FIG. 3. The corrosion resistant coating 50 may include any suitable coating material capable of preventing corrosion of the magnesium alloy material. For example, the corrosion resistant coating 50 may include but is not limited to an electro-deposition coating such is commonly applied to automotive body panels. The corrosion resistant coating 50 may be applied in any manner suitable for the application of the specific corrosion resistant coating 50. For example, assuming the corrosion resistant coating 50 is an electro-deposition coating, then the corrosion resistant coating 50 may be applied through an electro-deposition coating process whereby the inner panel 24 is submerged in a bath of the electro-deposition coating solution with an electric current used to deposit a protective coating onto the inner panel 24. Alternatively, dry polymer powder may be sprayed onto the inner panel 24 with electric charges being used to attach the powder to the inner panel 24. The powder is subsequently fused to the inner panel 24 in an oven.

Referring to FIG. 4, once the inner panel 24 is coated with the corrosion resistant coating 50, then the method may further include positioning the inner panel 24 relative to the outer panel 22. A hem adhesive (not shown) may be disposed on the interior surface 30 of the outer panel 22 prior to the inner panel 24 being positioned relative to the outer panel 22. The hem adhesive is compressed between the inner panel 24 and the outer panel 22, and may partially fill a gap formed between the edge 32 of the inner panel 24 and the outer panel 22. The inner panel 24 is positioned adjacent the outer panel 22 such that the edge 26 of the outer panel 22 extends beyond the rounded edge surface 44 of the inner panel 24, with the first surface 34 of the inner panel 24 adjacent the interior surface 30 of the outer panel 22. The edge 26 of the outer panel 22 is then bent around the rounded edge surface 44 of the inner panel 24, indicated by arrow 52, until the interior surface 30 of the outer panel 22 is adjacent and engages the second surface 36 of the inner panel 24, shown in phantom in FIG. 4 and in a final shape in FIG. 2, to form the hem connection 43 that secures the inner panel 24 relative to the outer panel 22.

While the best modes for carrying out the invention have been described in detail, those familiar with the art to which this invention relates will recognize various alternative designs and embodiments for practicing the invention within the scope of the appended claims.

1. A method of manufacturing a closure assembly for a vehicle, the method comprising:
trimming an outer panel to define an edge, wherein the outer panel is formed from an aluminum alloy material;
trimming an inner panel to define an edge, wherein the inner panel is formed from a magnesium alloy material;
abrasively shaping the edge of the inner panel to define a substantially rounded edge surface having a radius;
positioning the inner panel adjacent the outer panel such that the edge of the outer panel extends beyond the rounded edge surface of the inner panel; and
bending the edge of the outer panel around the rounded edge surface of the inner panel to form a hem connection that secures the inner panel relative to the outer panel.

2. A method as set forth in claim 1 wherein the inner panel includes a thickness, and wherein the radius of the rounded edge surface is between the range of one quarter (¼) the thickness of the inner panel and one half (½) the thickness of the inner panel.

3. A method as set forth in claim 2 wherein abrasively shaping the edge of the inner panel includes sanding the edge of the inner panel with a medium grit abrasive to round the edge and define the radius and to remove surface contaminants.

4. A method as set forth in claim 3 wherein abrasively shaping the edge of the inner panel includes sanding the edge of the inner panel with a fine grit abrasive after sanding with the medium grit abrasive to remove scratches left in the rounded edge surface by the medium grit abrasive.

5. A method as set forth in claim 4 wherein the medium grit abrasive includes a one hundred eighty (180) grit bonded silicon carbide abrasive, and wherein the fine grit abrasive includes a three hundred twenty (320) grit bonded silicon carbide abrasive.

6. A method as set forth in claim 2 wherein the inner panel includes a first surface having bondline region disposed adjacent the rounded edge surface and a second surface having a hem region disposed adjacent the rounded edge surface, and wherein the method further comprises abrasively finishing the bondline region and the hem region of the inner panel.

7. A method as set forth in claim 6 wherein abrasively finishing the bondline region and the hem region of the inner panel includes sanding the bondline region and the hem region with a medium grit abrasive to remove surface contaminants.

8. A method as set forth in claim 7 wherein abrasively finishing the bondline region and the hem region of the inner panel includes sanding the bondline region and the hem region with a fine grit abrasive after sanding with the medium grit abrasive to remove scratches left in the bondline region and the hem region by the medium grit abrasive.

9. A method as set forth in claim 8 wherein the medium grit abrasive includes a one hundred eighty (180) grit bonded silicon carbide abrasive, and wherein the fine grit abrasive includes a three hundred twenty (320) grit bonded silicon carbide abrasive.

10. A method as set forth in claim 6 further comprising coating the inner panel with a corrosion resistant surface treatment after abrasively shaping the rounded edge surface and abrasively finishing the bondline region and the hem region of the inner panel.

11. A method of finishing a panel for a vehicle, the method comprising:
abrasively shaping an edge of the panel to define a substantially rounded edge surface having a radius, and to remove surface contaminants, wherein the panel includes a magnesium alloy material, and wherein the radius of the rounded edge surface is between the range of one quarter (¼) a thickness of the panel and one half (½) the thickness of the panel; and
coating the panel with a corrosion resistant surface treatment after abrasively shaping the substantially rounded edge surface.

12. A method as set forth in claim 11 wherein abrasively shaping the edge of the panel includes sanding the edge of the panel with a medium grit abrasive.

13. A method as set forth in claim 12 wherein abrasively shaping the edge of the panel includes sanding the edge of the panel with a fine grit abrasive after sanding with the medium grit abrasive to remove scratches left in the rounded edge surface by the medium grit abrasive.

14. A method as set forth in claim 13 wherein the medium grit abrasive includes a one hundred eighty (180) grit bonded silicon carbide abrasive, and wherein the fine grit abrasive includes a three hundred twenty (320) grit bonded silicon carbide abrasive.

15. A method as set forth in claim 11 further comprising abrasively finishing a bondline region of the panel disposed adjacent the rounded edge surface on a first side surface of the inner panel, and a hem region of the inner panel disposed adjacent the rounded edge surface on a second side surface of the inner panel to remove surface contaminants, prior to coating the panel.

16. A method as set forth in claim 15 wherein abrasively finishing the bondline region and the hem region of the panel includes sanding the bondline region and the hem region with the medium grit abrasive.

17. A method as set forth in claim 16 wherein abrasively finishing the bondline region and the hem region of the panel includes sanding the bondline region and the hem region with the fine grit abrasive after sanding with the medium grit abrasive to remove scratches left in the bondline region and the hem region by the medium grit abrasive.

18. A method as set forth in claim 17 wherein the medium grit abrasive includes a one hundred eighty (180) grit bonded silicon carbide abrasive, and wherein the fine grit abrasive includes a three hundred twenty (320) grit bonded silicon carbide abrasive.

19. A closure assembly for a vehicle, the closure assembly comprising:
an outer panel having an edge and defining an exterior surface and an interior surface;
an inner panel having an edge and defining a first surface and a second surface;
wherein the inner panel is positioned adjacent the outer panel such that the first surface of the inner panel engages the interior surface of the outer panel along a bondline region, with the edge of the outer panel bent over and wrapped around the edge of the inner panel such that the interior surface of the outer panel engages the second surface of the inner panel along a hem region to define a hem connection; and
wherein the edge of the inner panel is abrasively shaped to define a substantially rounded edge surface having a radius.

20. A closure assembly as set forth in claim 19 wherein the inner panel includes a thickness, and wherein the radius of the rounded edge surface is approximately equal to one half (½) the thickness of the inner panel.
